(19) United States
(12) Patent Application Publication
(10) Pub. No.: US 2026/0208773 A1
(43) Pub. Date: Jul. 23, 2026

(54) TAKE-UP ARM, LOAD HANDLING DEVICE AND RELATED STORAGE AND RETRIEVAL SYSTEM

(71) Applicant: Ocado Innovation Limited, Hatfield (GB)

(72) Inventors: Måns Fredrik Jonathan NILSSON, Stockholm (SE); Arvid HÄLLJE, Stockholm (SE); Anton GRAHN, Stockholm (SE)

(21) Appl. No.: 19/568,897

(22) Filed: Mar. 17, 2026

Related U.S. Application Data
(63) Continuation of application No. PCT/EP2024/076652, filed on Sep. 23, 2024.

(30) Foreign Application Priority Data
Sep. 22, 2023 (GB) 2314571.7

(51) Int. Cl. B61F 5/50; B61B 5/02; B61C 13/04; B65G 1/04; G06Q 10/087

(52) U.S. Cl. CPC B61F 5/50; B61B 5/02; B61C 13/04; B65G 1/0464; G06Q 10/08741

(57) ABSTRACT

A take-up arm is provided for a load handling device. The take-up arm includes a limb extending from one side of the direction-change assembly, the limb being horizontally displaceable relative to a drive wheel and driven wheels of the load handling device when the direction-change assembly moves to raise or lower the set of wheels. A drive belt is further routed around the limb, the drive belt having a drive belt route, wherein the limb is extendable, movable between a retracted position and an extended position, and wherein the limb is arranged to be in the retracted position when the wheels are lowered, and the limb is arranged to be in the extended position when the wheels are raised thereby extending the route of the drive belt and take-up slack in the drive belt when the wheels are in the raised position.

### RELATED APPLICATIONS

This application is a continuation application of International Patent Application No. PCT/EP2024/076652 filed 23 Sep. 2024 and entitled “TAKE-UP ARM, LOAD HANDLING DEVICE AND RELATED STORAGE AND RETRIEVAL SYSTEM,” which claims priority to UK Patent Application No. GB2314571.7 filed 22 Sep. 2023 and entitled “TAKE-UP ARM, LOAD HANDLING DEVICE AND RELATED STORAGE AND RETRIEVAL SYSTEM”; the entire contents of both of which applications are incorporated herein by reference.

### TECHNICAL FIELD

The present disclosure relates to a take-up arm for load handling devices that are used in storage systems. More specifically, the disclosure relates to a take-up arm for use with a drive belt.

### BACKGROUND

Some commercial and industrial activities require systems that enable the storage and retrieval of a large number of different products. One known type of system for the storage and retrieval of items in multiple product lines involves arranging storage containers (also known as bins or totes) in stacks on top of one another, the stacks being arranged in rows. The storage containers are removed from the stacks and accessed from above by load handling devices, removing the need for aisles between the rows and thereby allowing a large number of containers to be stored in a given space.

As shown in FIGS. 1 and 2, storage containers 10, also known as bins or totes, are stacked on top of one another to form stacks 12. The stacks 12 are arranged in a grid framework structure 14 in a warehousing or manufacturing environment. The grid framework is made up of a plurality of storage columns or grid columns 24. Each grid in the grid framework structure has at least one grid column for storage of a stack of containers 12. FIG. 1 is a schematic perspective view of the grid framework structure 14, and FIG. 2 is a top-down view showing a single stack 12 of containers 10 arranged within the grid framework structure 14. Each container or bin 10 typically holds a plurality of product items (not shown), and the product items within a container 10 may be identical, or may be of different product types depending on the application. Each container 10 may be used to store grocery items (i.e. food items), for example. Furthermore, the bins 10 may be physically subdivided to accommodate a plurality of different inventory items.

In the description below, bins 10 will be used to denote the storage containers intended for the storage of inventory items, whereas delivery containers DT will be used to denote containers filled or intended to be filled to fulfil customer orders placed by customers. It will be appreciated that this terminology is used for ease of reference and explanation within this document. However, it should be noted that the bins 10 and the containers DT may be of the same shape and configuration. Furthermore, delivery containers DT may be stored in bins 10 within the storage system or any part thereof.

The grid framework structure 14 comprises a plurality of upright members or upright columns 16 that support horizontal grid members 18, 20. A first set of parallel horizontal grid members 18 is arranged perpendicularly to a second set of parallel horizontal grid members 20 to form a track system 15 comprising a plurality of grid cells extending in a substantially horizontal plane and supported by the upright members 16. The members 16, 18, 20 are typically manufactured from metal and typically welded or bolted together or a combination of both. The containers 10 are stacked between the members 16, 18, 20 of the grid framework structure 14, so that the grid framework structure 14 guards against horizontal movement of the stacks 12 of containers 10, and guides vertical movement of the containers 10.

The top level of the grid framework structure 14 includes rails 22 arranged in a grid pattern across the top of the stacks 12. Referring additionally to FIG. 3, the rails 22 support a plurality of load handling devices 30. A first set 22a of parallel rails 22 guide movement of the robotic load handling devices 30 in a first direction (for example, an X-direction) across the top of the grid framework structure 14, and a second set 22b of parallel rails 22, arranged perpendicular to the first set 22a, guide movement of the load handling devices 30 in a second direction (for example, a Y-direction), perpendicular to the first direction. In this way, the rails 22 allow movement of the robotic load handling devices 30 laterally in two dimensions in the horizontal X-Y plane, so that a load handling device 30 can be moved into position above any of the stacks 12.

Each load handling device 30 comprises a vehicle body 32 which is arranged to travel in the X and Y directions on the tracks or rails 22 of the grid frame structure 14, above the stacks 12 (see FIG. 4). FIGS. 4 and 5A and 5B show a load handling device 30 according to an embodiment of the present disclosure and described in PCT Patent Publication No. WO2015/019055 (Ocado Innovation Limited) and International patent application WO2015/185628A describes a storage and fulfilment system in which stacks of storage containers are arranged within a grid framework structure. The containers are accessed by load handling devices operative on tracks located on the top of the grid framework structure.

The load handling device 30 comprises a vehicle body 32 equipped with a lifting mechanism 33 (see FIG. 4) comprising a winch or a crane mechanism 35 to lift a storage container or bin 10, also known as a tote, from above. The crane mechanism 35 comprises a winch cable 38 wound on a spool or reel and a grabber device 39. Typically, the lifting device comprises a set of lifting tethers 38 extending in a vertical direction and connected nearby or at the four corners of the grabber device 39 (one tether near each of the four corners of the grabber device) for releasable connection to a storage container 10. The grabber device 39 is configured to grip the top of the storage container 10 and lift it from a stack of containers in a storage system of the type shown in FIGS. 1 and 2. Typically, the grabber device 39 is configured as a lifting frame.

The vehicle body 32 comprises an upper part and a lower part (see FIGS. 5A and 5B). The lower part is fitted with two sets of wheels 34, 36, which run on rails at the top of the framework structure of the storage system. The upper part of the vehicle body 32 may house a majority of the bulky components of the load handling device. Typically, the upper part of the vehicle body houses a driving mechanism for driving both the wheels and the lifting mechanism together with an on-board rechargeable power source for providing the power to the driving mechanism and the lifting mechanism.

The lower part of the vehicle body 32 comprises a wheel assembly that are driven to enable movement of the vehicle in X and Y directions respectively along the rails. A first set of wheels 34, consisting of a pair of wheels 34 on the front of the vehicle 32 and a pair of wheels 34 on the back of the vehicle 32, are arranged to engage with two adjacent rails of the first set 22a of rails 22. Similarly, a second set of wheels 36, consisting of a pair of wheels 36 on each side of the vehicle 32, are arranged to engage with two adjacent rails of the second set 22b of rails 22. One or both sets of wheels can be moved vertically to lift each set of wheels clear of the respective rails, thereby allowing the vehicle to move in the desired direction. When the first set of wheels 34 is engaged with the first set of tracks or rails 22a and the second set of wheels 36 are lifted clear from the tracks or rails 22, the wheels 34 can be driven, by way of a drive mechanism (not shown) housed in the vehicle 32, to move the load handling device 30 in the X direction. To move the load handling device 30 in the Y direction, the first set of wheels 34 are lifted clear of the tracks or rails 22, and the second set of wheels 36 are lowered into engagement with the second set of tracks or rails 22a. The drive mechanism can then be used to drive the second set of wheels 36 to achieve movement in the Y direction. One or both sets of wheels can be moved vertically to lift each set of wheels clear of the respective rails, thereby allowing the vehicle to move in the desired direction on the track system.

The wheels are arranged around the periphery of a cavity or recess, known as a container-receiving recess 40, in the lower part. The recess 40 is sized to accommodate the storage container or bin 10 when it is lifted by the crane mechanism, as shown in FIGS. 5A and 5B. When in the recess, the container is lifted clear of the rails beneath, so that the load handling device can move laterally to a different location. On reaching the target location, for example another stack, an access point in the storage system or a conveyor belt, the bin or storage container can be lowered from the container receiving space and released from the grabber device 39. In this way, one or more robotic load handling devices 30 can move around the top surface of the stacks 12 on the frame structure 14, as shown in FIG. 3 under the control of a centralised control utility (not shown). Each robotic load handling device 30 is provided with a lifting mechanism for lifting one or more bins 10 from the stack 12 to access the required items stored therein.

The body of the vehicle 32 can comprise the container receiving space 40 in the form of a cavity for accommodating a bin 10 (see FIGS. 5A and 5B). The cavity 40 being of a size capable of holding a bin or storage container 10. The lifting mechanism comprising a set of lifting tethers 38 extending in a vertical direction are connected at the four corners of a lifting frame (not shown), otherwise known as the grabber device (one tether near each of the four corners of the grabber device) for releasable connection to a storage container. The grabber device is configured to releasably grip the top of a storage container to lift it from a stack of containers in a storage system of the type shown in FIGS. 1 and 3. The lifting mechanism lifts a bin 10 from the stack 12 to within the cavity 40 within the body of the vehicle 32. Even though the container receiving space 40 (for accommodating a bin 10 when it is lifted by the winch means) is arranged within the vehicle body 32 shown in FIG. 4, the present disclosure is not limited to the container receiving space 40 being located within the vehicle body 32. The present disclosure is also applicable to the container receiving space being located below a cantilever such as in the case where the vehicle body of the load handling device has a cantilever construction as described in WO2019/238702 (Autostore Technology AS). The term ‘vehicle body” is construed to optionally cover a cantilever such that the grabber device is located below the cantilever. However, for ease of explanation, the container receiving space for receiving a container is arranged within a cavity or recess within the vehicle body. The container receiving space allows multiple products to be accessed from multiple locations in the grid and stacks at any one time.

The robotic load handling devices 30 remove bins 10 containing inventory items (not shown) therein and transport the bins 10 to pick stations (not shown) where the required inventory items 28 are removed from the bins 10 and placed into bins 10 comprising delivery containers DT. It is important to note that a delivery container DT may fit within a bin 10. The bins 10 may comprise inventory items or may comprise delivery containers DT. Furthermore, the delivery containers DT may comprise at least one bag, the inventory items being picked directly in to a bag at a pick station (not shown).

The empty bins 10 or the bins comprising delivery containers DT or the bins comprising delivery containers DT and bags may all be stored within the stacks 12. It will be appreciated that all the bins 10 have substantially the same external shape and configuration.

FIG. 3 shows a typical storage and retrieval system 1 as described above, the system having a plurality of load handling devices 30 active on the grid above the stacks 12. FIGS. 1 and 3 show the bins 10 in stacks 12 within the storage system. It will be appreciated that there may be a large number of storage containers or bins 10 in any given storage system and that many different items may be stored in the bins 10 in the stacks 12, each bin 10 may contain different categories of inventory items within a single stack 12.

International Patent Application Publication No. WO2021/175940 (Ocado Innovation Limited) describes a load handling device which is driven by a drive belt arrangement. More specifically WO '940 describes tensioning means for tensioning a drive belt in a load handling device. The wheels are driven by a drive belt assembly for driving each of the first and second sets of wheels. The raising and lowering of the wheels for engagement or disengagement with the tracks, and the transition between x- and y-direction movements are controlled by a direction-change mechanism. As the direction-change mechanism transitions between position for x- and y-direction movements, the tensioning means engages the drive belt in order to maintain tension in the drive belt.

Coordination and engagement between the drive belt assembly, the tensioning means and the wheels is required for the load handling device to reliably move along the tracks in the x- and y-directions.

A load handling device which can reliably drive in x- and y-directions is required for grid-based storage systems.

It will be appreciated that while the system, apparatus and devices described herein are described for using grocery systems as an example, automated or semi-automated storage and retrieval systems are not limited to systems directed to groceries. For example, the technology can be applied to non-grocery storage, self-storage facilities, manufacturing facilities and general logistics to name a few possible applications. It will be appreciated that storage and retrieval systems of different types will have different technical requirements.

It is against this background that the present disclosure has been devised.

### SUMMARY

Aspects of the disclosure are set out in the accompany claims.

In a first aspect, there is provided a take-up arm, for a load handling device, the load handling device comprising:
a body mounted on a first set of wheels being arranged to engage with a first set of parallel tracks and a second set of wheels being arranged to engage with a second set of parallel tracks;
a direction-change mechanism arranged to raise or lower the first set of wheels and or lower or raise the second set of wheels for engaging and disengaging the wheels with the parallel tracks; and
a plurality of drive belt assemblies each comprising a drive belt, a drive wheel, and a take-up arm, wherein the drive belt is routed around a respective set of wheels, and the first set of wheels and the second set of wheels are driven by respective drive belt assemblies, the first set of wheels and the second set of wheels being driven wheels;
The take-up arm comprising:
a limb extending from one side of the direction-change mechanism, the limb being horizontally displaceable relative to the drive wheel and the driven wheels when the direction-change mechanism moves to raise or lower the set of wheels, and the drive belt is further routed around the limb, the drive belt having a drive belt route, wherein
the limb is extendable, movable between a retracted position and an extended position, and wherein
the limb is arranged to be in the retracted position when the wheels are lowered, and the limb is arranged to be in the extended position when the wheels are raised thereby extending the route of the drive belt and tensioning the drive belt when the wheels are in the raised position.

The load handling device may be of any of the types described herein. More particularly, the load handling device may be one which is driven by a drive belt arrangement having a direction-change mechanism that raises and lowers the wheel sets.

The direction-change mechanism may comprise any suitable mechanism for engaging and disengaging (lowering and raising) the first set of wheels and the second set of wheels to enable movement of the load handling device in x-and y-directions.

In one example, the direction-change mechanism may be in the form of a cam mechanism comprising a traveller, a follower and a cam profile, for example as described in WO2023/025882 (Ocado Innovation Limited), and corresponding U.S. Patent Application Publication No. 2024/0375868 (Ocado Innovation Limited), the entire content of which is incorporated herein by reference. The cam profile may comprise at least one slot (e.g. two slots) in the face of a fixed brace. The brace may be attached to, joined to or uniform with the wheel chassis such that movement of the brace results in movement of the wheel chassis and therefore the driven wheels supported on the wheel chassis. In particular, vertical movement of the brace may result in vertical movement of the wheel chassis, thereby moving the wheels between the raised and lowered positions. Another direction-change mechanism is described in WO2021/175922 (Ocado Innovation Limited) and corresponding U.S. Pat. No. 12,344,471 (Ocado Innovation Limited), the entire content of which is incorporated herein by reference. The skilled person will be aware of other suitable mechanisms.

The drive belt may be routed around the drive wheel such that rotation of the drive wheel may drive the drive belt thereby driving the driven wheels. In particular, the drive belt may be a toothed drive belt which engages with the driven wheels, for example the toothed edge of each of the driven wheels, such that driving the drive belt rotates the driven wheels and drives the load handling device.

The drive belt assembly may enable the load handling device to move on top of a storage structure by moving the load handling device across a track structure provided on the top of the storage structure. The track structure may comprise a first set of x-direction tracks and a second set of y-direction tracks extending substantially perpendicularly to the first set of track in a substantially horizontal plane to form a grid pattern. The driven wheels may comprise a first set of wheels for engaging with the x-direction track and a second set of wheels for engaging with the y-direction tracks. For moving the load handling device in the x-direction, the first set of wheels may be engaged with the x-direction track, while the second set of wheels may be raised. Similarly, for moving the load handling device in the y-direction, the second set of wheels may be engaged with the y-direction track while the first set of wheels may be raised.

The driven wheels may be connected to a lower portion of the load handling device while the drive wheel may be mounted to an upper portion of the load handling device. The distance between the upper and lower portions of the load handling device may change in order to raise and lower the wheels from the tracks, thereby changing the distance between the drive wheel and the driven wheels. The distance between the upper portion of the load handling device and the lower portion of the load handling device may define a route length of the drive belt. In particular, the distance around the drive wheel and the driven wheels defines a route length of the drive belt. The drive belt may be mounted to the upper portion of the load handling device by the drive wheel. The drive belt may also be mounted to the upper portion of the load handling device by a slave wheel which guides the drive belt along a belt path on the upper portion of the load handling device.

Under control of the direction-change mechanism, the lower portion of the load handling device may be raised in order to raise the driven wheels from the track thereby reducing the distance between the upper and lower portions of the load handling device and as such changing the route length of the drive belt from a first route length when the driven wheels are in the lowered position to a second shorter route length when the driven wheels are in the raised position. The lower portion of the load handling device may comprise a wheel chassis to which the driven wheels are mounted or attached. The wheel chassis may be raised or lowered to raise or lower the driven wheels from the tracks.

Thus, the direction-change assembly may cause the drive belt route to be altered. This may cause the drive belt to become slack and become lose or disengaged with the driven wheels. A slack belt may get caught on something exterior to the load handling device. When the wheels are raised by the direction-change mechanism, it is not expected that the wheels will be driven. However, if the belt becomes too loose and disengages with the driven wheels, when the wheels are subsequently lowered the belt may not be positioned correctly to correctly re-engage with the wheels. Further, loose engagement between the drive belt and the driven wheels may not be effective in transferring drive from the belt to the driven wheels resulting in inaccurate movements of the load handling device.

The take-up arm is used to take-up slack in the drive belt when wheels are raised to maintain the overall route length of the drive belt, and to maintain a minimal tension in the drive belt.

The limb is movable between retracted and extended positions. In the extended positon, the limb takes up any slack in the drive belt, for example, when the wheels are in the raised position. The extension of the limb maintains engagement between the drive belt and the wheels, ensuring the drive belt assembly to accurately drive the wheels as required. The limb may re-route the drive belt by a distance sufficient to take up any slack in the drive belt and with a force sufficient to provide tension to maintain engagement between the drive belt and the driven wheels when the wheels are in the raised position, and to enable the load handling device to drive without slippage of the drive belt when the wheels are in the lowered position.

The limb is attached to one side of the direction-change mechanism. Thus, the take-up arm is mechanically linked to the direction-change mechanism such that movement of the wheels between the lowered position and the raised position may be mechanically coordinated with movement of the limb between the retracted and extended configuration.

In use, movement of the driven wheels from the lowered position to the raised position may be configured to move the limb from the retracted configuration to the extended configuration. Similarly, movement of the driven wheels from the raised position to the lowered position may be configured to move the limb from the extended configuration to the retracted configuration. In particular, the direction-change mechanism may be moveable between a first position when the driven wheels are in the lowered position and a second position when the driven wheels are in the raised position. By attaching the take-up arm to the direction-change mechanism, the direction-change mechanism may advantageously move the limb between the retracted configuration and the extended configuration to take up slack of the drive belt as the direction-change mechanism moves between the first and second position.

The limb comprises an extended position where the first portion is extended from the second portion.

The limb may comprise a first portion and a second portion, and the second portion is arranged to telescope out from the first portion.

The second portion may telescope out from the first portion when in the extended configuration. In other words, the second portion may extend from the first position along a same elongate axis of the first portion. The limb comprises a retracted configuration where the first portion and the second portion are retracted. The second portion may telescope into the first portion when in the retracted configuration, where the second portion is nested within the first portion.

This advantageously allows the limb to occupy less space within the load handling device.

In an alternative arrangement, the second portion may extend away from the first portion along a different elongate axis of the first portion (e.g. along an elongate axis adjacent to the elongate axis of the first portion) and may retract next to the first portion when in the retracted configuration. For example, the second portion may concertina away from the first portion when in the extended configuration.

To engage (or re-engage) the driven wheels with the track, the lower portion of the load handling device may be lowered in order to lower the driven wheels onto the track. This increases the distance between the upper and lower portions of the load handling device and as such may increase the drive belt route length from a shorter route length to a longer route length. By increasing the route length, the drive belt may be tensioned around the driven wheels (and the drive wheel) thereby restoring the proper or required engagement between the drive belt and the driven wheels. When the limb is no longer required to tension the drive belt and the limb may be moved into the retracted configuration.

The first portion of the limb is attached to the direction-change mechanism such that horizontal movement of the direction-change mechanism results in horizontal movement of the first portion. In particular, the direction-change mechanism may move horizontally in a first direction from the first position to the second position, moving the first portion horizontally in the first direction, extending the first portion away from the second portion and allowing the second portion to telescope out from the first portion.

The take-up arm may further comprise a stop tab located on the body of the load handling device and arranged to engage with the limb to push the limb from the extended position to the retracted position with movement of the direction-change mechanism from a wheels raised position to a wheels lowered position.

As the direction-change mechanism moves from the second position to the first position, the second portion may abut against the stop tab. With continued movement of the direction-change mechanism (and limb), the second portion of the limb may be retracted towards the first portion. In particular, the second portion may be retracted or nested into the first portion i.e. telescope into the first portion. Thus, the stop tab advantageously returns the limb from the extended configuration to the retracted configuration without the need for a biasing element (e.g. a spring).

The limb may comprise a slot for routing the drive belt through. This provides a robust and effective way of coupling the drive belt to the limb.

The limb may comprise a hook for routing the drive belt through.

In another aspect, there is provided a load handling device for operating on a grid framework storage structure comprising:
a first set of parallel rails or tracks and a second set of parallel rails or tracks extending substantially perpendicularly to the first set of rails or tracks in a substantially horizontal plane to form a grid pattern comprising a plurality of grid spaces, wherein the grid is supported by a set of uprights to form a plurality of vertical storage locations beneath the grid for containers to be stacked between and be guided by the uprights in a vertical direction through the plurality of grid spaces,
the load handling device comprising:
a body mounted on a first set of wheels being arranged to engage with the first set of parallel tracks and a second set of wheels being arranged to engage with the second set of parallel tracks,
a direction-change assembly arranged to raise or lower the first set of wheels and or lower or raise the second set of wheels for engaging and disengaging the wheels with the parallel tracks; and
a plurality of drive belt assemblies each comprising a drive belt, a drive wheel, and a take-up arm, wherein the first set of wheels and the second set of wheels are driven wheels driven by respective drive belt assemblies, and raised or lowered by the direction-change assembly.

The load handling device may comprise four drive belt assemblies, one arranged on each side of the load handling device.

The load handling device may comprise four take-up arms, one arranged on each side of the load handling device for tensioning respective drive belts on each side of the load handling device. The load handling device may comprise a direction-change assembly configured to raise and lower the driven wheels for engaging and disengaging the driven wheels with the tracks. The direction-change assembly may comprise four direction-change mechanisms, one arranged on each side of the load handling device for raising and lowering respective driven wheels for engaging and disengaging with the tracks.

Thus, the direction-change assembly may selectively position the first and second sets of wheels for movement of the load handling device in the x-direction or the y-direction across the tracks. As described above, the direction-change assembly may lower the first set of wheels for engagement with the x-direction track while the second set of wheels may be raised for x-direction movement of the bot. The direction-change assembly may lower the second set of wheels for engagement with the y-direction track while the first set of wheels may be raised for y-direction movement of the bot.

The take-up arm may be attached to the direction-change assembly and movement of the limb is coordinated with raising or lowing movement of the wheels.

The direction-change mechanism may be arranged in an intermediate position where when the first set of wheels and the second set of wheels are lowered, each of the respective limbs are arranged in an intermediate position where the limb is extended.

The direction-change assembly may position both the first and second sets of wheels in the lowered position for simultaneous engagement with the x- and y-direction tracks respectively, i.e. the load handling device may be in a parked configuration. In parked configuration, the direction-change mechanism may be moveable to an intermediate position between the first position and the second position. As both the first and second sets of wheels are in the lowered positions, the route length of the respective drive belts between the set of wheels and the driven wheels on each side of the load handling device may be the first span length and the drive belts may not be slack. The direction-change mechanism may be configured to move the take-up arm (e.g. horizontally) to an intermediate position where the span length of the drive belts is maintained at the first span length and where the limb may not tension the drive belt. The direction-change mechanism at the intermediate position may be configured to move the limb into the extended configuration.

In another aspect, there is provided a grid-based storage and retrieval system comprising:
a grid framework structure comprising:
a first set of parallel rails or tracks and a second set of parallel rails or tracks extending substantially perpendicularly to the first set of rails or tracks in a substantially horizontal plane to form a grid pattern comprising a plurality of grid spaces, wherein the grid is supported by a set of uprights to form a plurality of vertical storage locations beneath the grid for containers to be stacked between and be guided by the uprights in a vertical direction through the plurality of grid spaces,
at least one load handling device as described above, operating on the grid framework structure; and
a centralised control utility for controlling the at least one load handling device.

In another example, a take-up arm is provided for a load handling device, the load handling device comprising:
a body mounted on a first set of wheels being arranged to engage with a first set of parallel tracks and a second set of wheels being arranged to engage with a second set of parallel tracks;
a direction-change assembly arranged to raise or lower the first set of wheels and or lower or raise the second set of wheels for engaging and disengaging the wheels with the parallel tracks; and
at least one drive belt assembly each comprising a drive belt, a drive wheel, and a take-up arm, wherein each drive belt is routed around a respective pair of the first set of wheels or of the second set of wheels;
each respective take-up arm comprising:
a limb extending from one side of the direction-change assembly, the limb being horizontally displaceable when the direction-change assembly moves to raise or lower a respective set of wheels, and the respective drive belt is further routed around the limb, the respective drive belt having a drive belt route, wherein
the limb is extendable, movable between a retracted position and an extended position, and wherein
the limb is arranged to be in the retracted position when the respective set of wheels are lowered, and the limb is arranged to be in the extended position when the respective set of wheels are raised thereby extending the route of the respective drive belt and take-up slack in the respective drive belt when the respective set of wheels are in the raised position.

The first set of wheels may consist of a pair of wheels on the front of the vehicle and a pair of wheels on the back of the vehicle, and the second set of wheels may consist of a pair of wheels on each side of the vehicle.

A load handling device is provided for operating on a grid framework storage structure comprising:
a first set of parallel rails or tracks and a second set of parallel rails or tracks extending substantially perpendicularly to the first set of rails or tracks in a substantially horizontal plane to form a grid pattern comprising a plurality of grid spaces, wherein the grid is supported by a set of uprights to form a plurality of vertical storage locations beneath the grid for containers to be stacked between and be guided by the uprights in a vertical direction through the plurality of grid spaces,
the load handling device comprising:
a body mounted on a first set of wheels being arranged to engage with the first set of parallel tracks and a second set of wheels being arranged to engage with the second set of parallel tracks,
a direction-change assembly arranged to raise or lower the first set of wheels and or lower or raise the second set of wheels for engaging and disengaging the wheels with the parallel tracks; and
at least one drive belt assembly each comprising a drive belt, a drive wheel, and a take-up arm, wherein a respective pair of the first set of wheels or of the second set of wheels is driven by each respective drive belt assembly, and raised or lowered by the direction-change assembly.

Other variations and advantages will become apparent from the following description.

### BRIEF DESCRIPTION OF THE DRAWINGS

Features and aspects will be apparent from the following detailed description of an illustrative embodiment made with reference to the drawings, in which:

FIG. 1 is an illustration of a known automated storage and retrieval system;

FIG. 2 is a schematic diagram of a top-down view showing a stack of bins arranged within the framework structure of FIG. 1;

FIG. 3 is a schematic diagram of a system of a known load handling device operating on the grid framework structure;

FIG. 4 is a schematic front view of the load handling device;

FIGS. 5A and 5B are schematic perspective cut away views of the load handling device of FIG. 4 showing (FIG. 5A) a container receiving space of the load handling device accommodating a container and (FIG. 5B) a container lowered from the container receiving space by the load handling device;

FIG. 6 is a schematic perspective view of an example embodiment of a load handling device according to the present disclosure;

FIG. 7 is a front schematic view of a load handling device with an embodiment of take-up arm;

FIG. 8 is a detailed schematic view of a portion of the take-up arm of FIG. 7;

FIGS. 9A, 9B and 9C show front views of the load handing device of FIG. 7 with the load handing device in the x-direction movement configuration (FIG. 9A), the parked configuration (FIG. 9B) and the y-direction movement configuration (FIG. 9C);

FIG. 10 is a front schematic view of the take-up arm of FIG. 7 in the retracted configuration;

FIG. 11 is a front schematic view of the take-up arm of FIG. 7 in the extended configuration;

FIG. 12 is a perspective front view of the take-up arm of FIG. 7 in the retracted configuration;

FIG. 13 is a perspective front view of the take-up arm of FIG. 7 in the extended configuration;

FIG. 14 is a front schematic view of the take-up arm of FIG. 7 when the load handing device is in the parked configuration and the take-up arm is at an intermediate position;

FIG. 15 is a perspective front view of the take-up arm of FIG. 7 when the load handing device is in the parked configuration and the take-up arm is at an intermediate position;

FIG. 16 is a detailed front view of the take-up arm of FIG. 7;

FIGS. 17A, 17B, and 17C are perspective front views of an embodiment of a take-up arm, showing (FIG. 17A) a fixed portion and a sliding portion of the take-up arm, (FIG. 17B) the fixed portion, (FIG. 17C) the sliding portion;

FIGS. 18A, 18B, and 18C are perspective front views of the take-up arm of FIGS. 17A, 17B, and 17C, showing the sliding portion and the fixed portion being assembled together; and

FIGS. 19A and 19B are front schematic views of the take-up arm of FIGS. 17A, 17B, and 17C in (FIG. 19A) extended position, and (FIG. 19B) retracted position.

In the figures, like features are denoted by like reference signs where appropriate.

### DETAILED DESCRIPTION

The following embodiments represent preferred examples of how the invention may be practised, but they are not necessarily the only examples of how this could be achieved. These examples are described in sufficient detail to enable those skilled in the art to practise the invention. Other examples may be utilised and structural changes may be made without departing from the scope of the invention as defined in the appended claims. Moreover, direction references and any other terms having an implied orientation are given by way of example to aid the reader's understanding of the particular examples described herein. They should not be read to be requirements or limitations, particularly as to the position, orientation, or use of the invention unless specifically set forth in the appended claims. Similarly, connection references (e.g., attached, coupled, connected, joined, secured, and the like) are to be construed broadly and may include intermediate members between a connection of elements and relative movement between elements. As such, connection references do not necessarily infer that two elements are directly connected and in fixed relation to each other, unless specifically set forth in the appended claims. Similarly, wording such as “in the n-direction” and any comparable wording, where n is one of x, y, or z, is intended to mean substantially along or parallel to the n-axis in either direction (i.e. towards the positive end of the n-axis or towards the negative end of the n-axis).

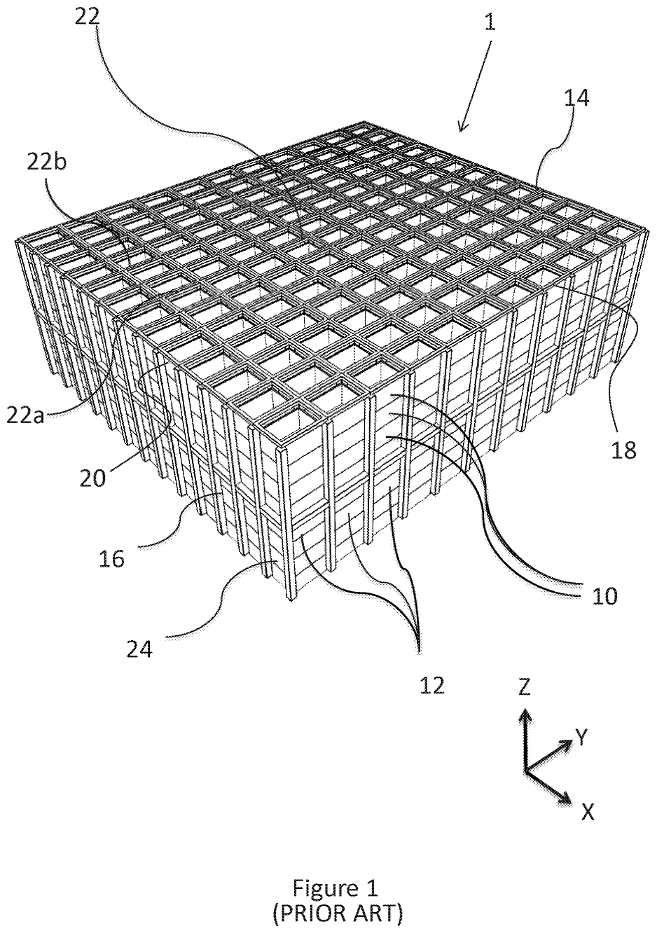

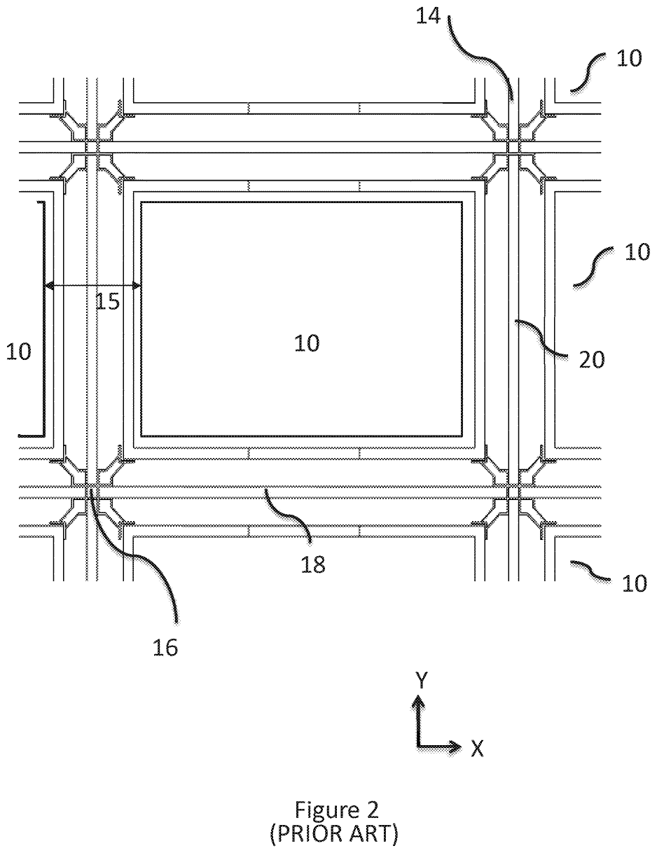

FIGS. 1 to 3 of the accompanying drawings illustrate a storage and retrieval system. As shown in FIGS. 1 and 2, stackable containers, known as storage bins or containers 10, are stacked on top of one another to form stacks 12. The stacks 12 are arranged in a three-dimensional (3D) grid framework structure 14 in a warehousing or manufacturing environment. The grid framework structure is made up of a plurality of storage columns or grid columns. FIG. 1 is a schematic perspective view of the grid framework structure 14, and FIG. 2 is a top-down view showing a stack 12 of bins 10 arranged within the framework structure 14. Each bin 10 typically holds a plurality of product items (not shown), and the product items within a bin 10 may be identical, or may be of different product types depending on the application. Bins 10 may also be referred to as storage bins or containers or storage containers or totes.

The grid framework structure comprises a supporting framework structure, upon which is mounted a track system for supporting the load handling devices. In the particular example of a grid framework structure illustrated in FIGS. 1 to 3, the supporting framework structure 14 comprises a plurality of vertical uprights or upright members or upright columns 16 that support horizontal grid members 18, 20. A first set of parallel horizontal grid members 18 is arranged perpendicularly to a second set of parallel horizontal grid members 20 to form a grid structure or grid 15 comprising a plurality of grid cells 17. The grid cell has an opening to allow a load handling device to lift a container or storage bin through the grid cell. In the grid structure, the first set of parallel horizontal grid members 18 intersect the second set of parallel horizontal grid members at nodes. The grid structure 15 is supported by the upright members 16 at each of the nodes or at the point where the grid members intersect such that the upright members are interconnected at their tops ends by the intersecting grid members. The grid members 16, 18, 20 are typically manufactured from metal and typically welded or bolted together or a combination of both. The storage bins or containers 10 are stacked between the upright members 16 of the grid framework structure 14, so that the upright members 16 guard against horizontal movement of the stacks 12 of bins 10, and guide vertical movement of the storage bins 10.

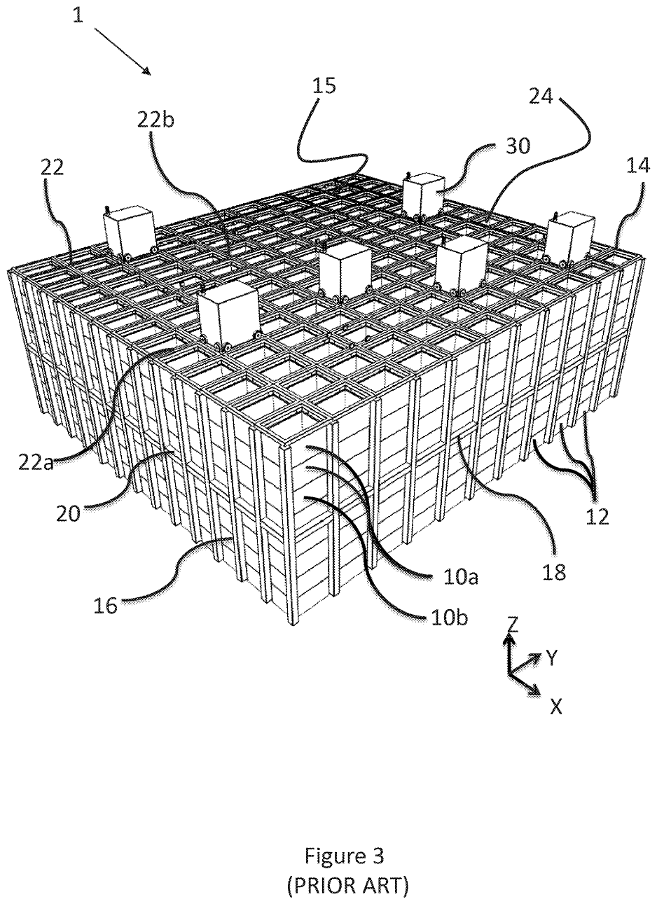

The top level of the grid framework structure 14 includes rails 22 arranged in a grid pattern across the top of the stacks 12. Referring additionally to FIG. 3, the rails 22 support a plurality of load handling devices 30. A first set 22a of parallel rails 22 guide movement of the robotic load handling devices 30 in a first direction (for example, an X-direction) across the top of the grid framework structure 14, and a second set 22b of parallel rails 22, arranged perpendicular to the first set 22a, guide movement of the load handling devices 30 in a second direction (for example, a Y-direction), perpendicular to the first direction. In this way, the rails 22 allow movement of the robotic load handling devices 30 laterally in two dimensions in the horizontal X-Y plane, so that a load handling device 30 can be moved into position above any of the stacks 12.

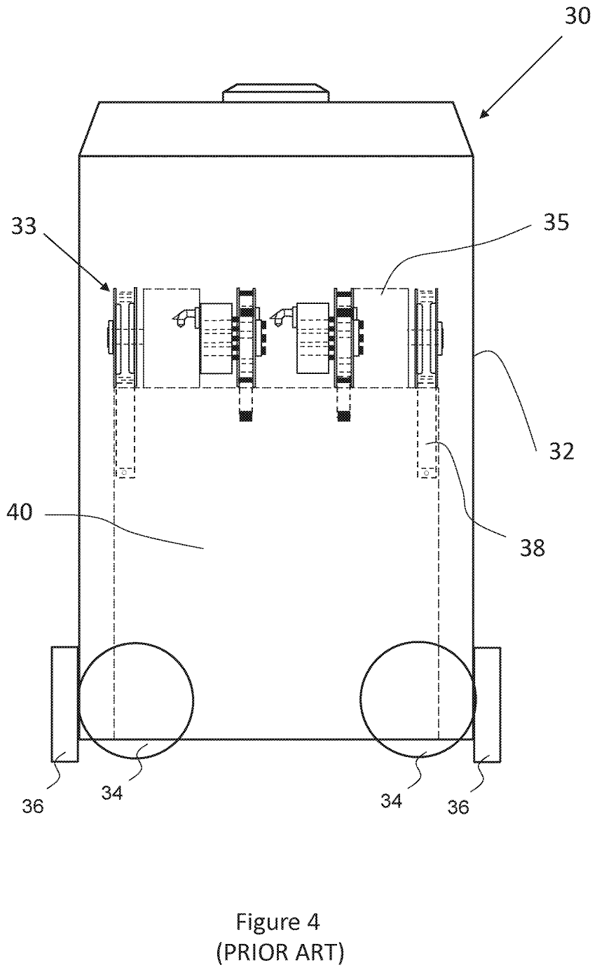

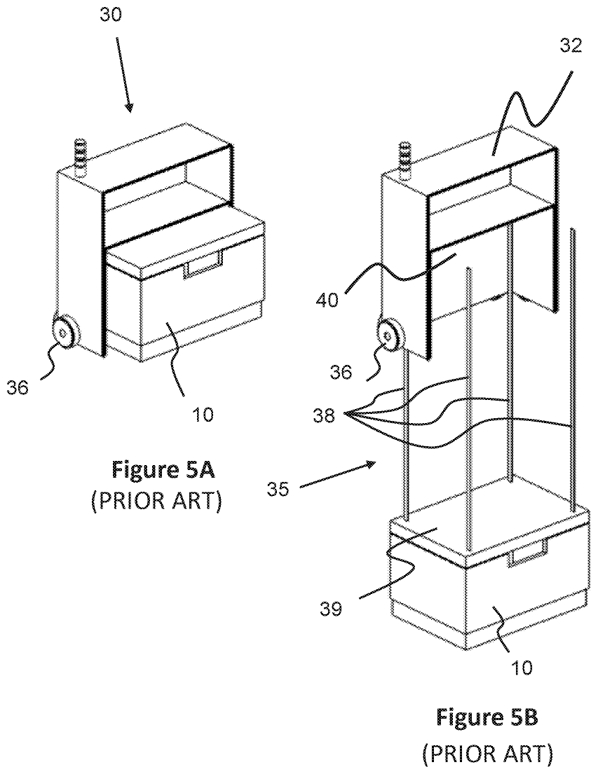

A load handling device or robotic load handling device otherwise known as a bot 30 shown in FIGS. 4 and 5 comprising a vehicle body 32 is described in PCT Patent Publication No. WO2015/019055 (Ocado Innovation Limited) and corresponding U.S. Pat. No. 10,000,337 (Ocado Innovation Limited), which U.S. patent is hereby incorporated by reference in its entirety, where each load handling device 30 only covers a single grid space or grid cell of the grid framework structure 14. Here, the load handling device 30 comprises a wheel assembly comprising a first set of wheels 34 consisting of a pair of wheels on the front of the vehicle body 32 and a pair of wheels 34 on the back of the vehicle 32 for engaging with the first set of rails or tracks to guide movement of the device in a first direction, and a second set of wheels 36 consisting of a pair of wheels 36 on each side of the vehicle 32 for engaging with the second set of rails or tracks to guide movement of the device in a second direction. Each of the sets of wheels are driven to enable movement of the vehicle in X and Y directions respectively along the rails. One or both sets of wheels can be moved vertically to lift each set of wheels clear of the respective rails, thereby allowing the vehicle to move in the desired direction, e.g. X or Y direction on the grid structure.

International Patent Application Publication No. WO2017/153583 (Ocado Innovation Limited) teaches a load handling device comprising a wheel positioning mechanism or directional change mechanism for enabling lateral movement of the device in one of two transverse directions by enabling either a first or second set of wheels to selectively engage the first or second set of rails or tracks (22a or 22b). The wheel positioning mechanism comprises a complicated arrangement of linkages driven by a linear actuator or motor to selectively lower or raise the first set of wheels or the second set of wheels into engagement or disengagement with the first set of tracks or rails or the second set of tracks or rails. Corresponding U.S. Pat. No. 11,273,980 (Ocado Innovation Limited) is incorporated herein by reference in its entirety.

The load handling device 30 is equipped with a lifting mechanism or container lifting mechanism or crane mechanism 39 to lift a storage container from above. The crane mechanism comprises a winch tether or cable 38 wound on a spool or reel (not shown) and a grabber device 39 in the form of a lifting frame. The lifting device comprise a set of lifting tethers 38 extending in a vertical direction and connected nearby or at the four corners of the lifting frame 39, otherwise known as the grabber device (one tether near each of the four corners of the grabber device) for releasable connection to a storage container 10. The grabber device 39 is configured to releasably grip the top of a storage container 10 to lift it from a stack of containers in a storage system of the type shown in FIGS. 1 and 2.

The wheels 34, 36 are arranged around the periphery of a cavity or recess, known as a container-receiving recess 40, in the lower part. The recess is sized to accommodate the container 10 when it is lifted by the crane mechanism, as shown in FIGS. 5A and 5B. When in the recess, the container is lifted clear of the rails beneath, so that the vehicle can move laterally to a different location. On reaching the target location, for example another stack, an access point in the storage system or a conveyor belt, the bin or container can be lowered from the container receiving portion and released from the grabber device. The container receiving space may comprise a cavity or recess arranged within the vehicle body, e.g. as described in the above-referenced WO 2015/019055 (Ocado Innovation Limited). Alternatively, the vehicle body of the load handling device may comprise a cantilever as taught in WO2019/238702 (Autostore Technology AS), in which case the container receiving space is located below a cantilever of the load handing device. In this case, the grabber device is hoisted by a cantilever such that the grabber device is able to engage and lift a container from a stack into a container receiving space below the cantilever.

Typically, the load handling device comprises one or more electrical components such as a rechargeable power source to provide power to the drive units for operating the lifting mechanism and the wheel positioning mechanism and a control unit. For example, one or more load handling devices remotely operable on the grid structure are configured to receive instructions from a master controller to retrieve a storage container from a particular a storage location within the grid framework structure. Wireless communications and networks may be used to provide the communication infrastructure from the master controller via one or more base stations to the one or more load handling devices operative on the grid structure. A controller in the load handling device in response to receiving the instructions is configured to control various driving mechanisms to control the movement of the load handling device. For example, the load handling device may be instructed to retrieve a container from a storage column at a particular location on the grid structure. The instruction can include various movements in an X-Y direction on the grid structure. Once at the storage column, the lifting mechanism is then operated to grab the storage container and lift it into a container receiving space in the body of the load handling device where it is subsequently transported to another location on the grid structure commonly known as a drop off port. The container is lowered to a suitable pick station allow retrieval of the item from the storage container. Movement of the load handling devices on the grid structure also involves the load handling devices being instructed to move to a charging station that is usually located at the periphery of the grid structure. The electrical components of the load handling device are typically housed within the body of the load handling device.

The specific example of a load handling device illustrated in FIGS. 4 and 5 shows the load handling device 30 with a body that is substantially box-shaped with four sidewalls and a top wall, with the components of the load handling device housed within the body. In other examples the body may comprise an open frame or skeleton structure, within or upon which components of the load handling device are supported.

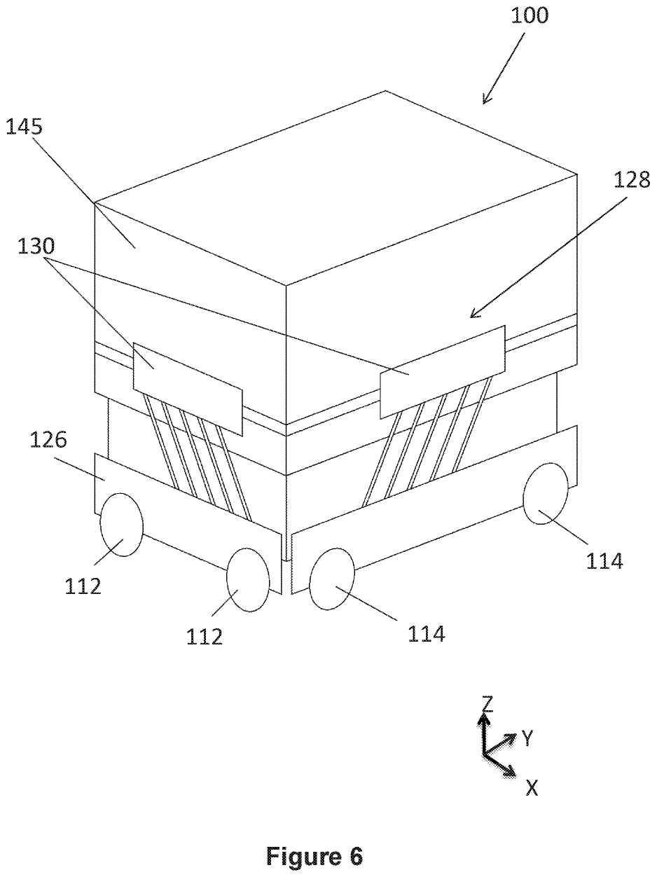

FIG. 6 shows an embodiment of bot 100, where the bot comprises a skeleton, i.e. a body or frame which supports, carries or houses the components of the bot (for example the battery and associated electronics, controller and communications devices, motors for driving the wheels, motors for driving the crane mechanism and other sensors and systems. The bot skeleton 100 comprises a recess, sized to accommodate a container when the container is lifted by the crane mechanism. The skeletal structure of the bot helps to ensure that the components of the bot are easily accessible.

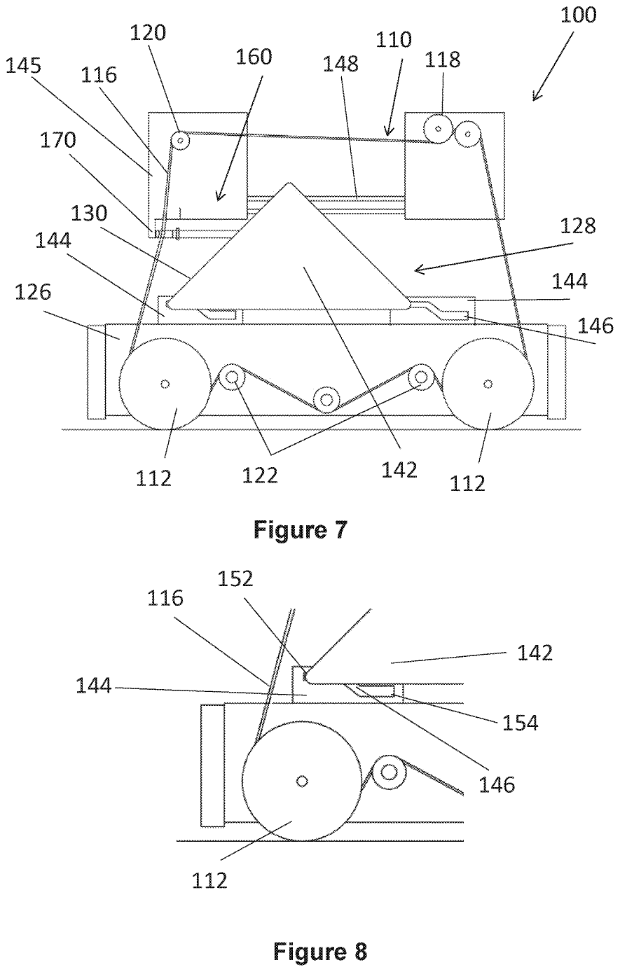

As shown in FIG. 7, the bot 100 comprises a drive belt assembly 110 to enable the bot 100 to move on top of the structure, i.e. move across the track structure 14. A drive belt assembly 110 is provided for each set of wheels 112, 114 on each side of the bot 100. Each drive belt assembly 110 comprises a drive belt 116, a drive wheel 118 for diving the drive belt 116, one or more slave wheels 120 for routing the drive belt 116 and one or more tensioning wheels 122. The drive wheel 118 is driven and is linked to the axle of a motor (not shown) and drives the drive belt 116. The drive belt 116 engages with both wheels of the set of wheels 112, 114 on the side of the bot 100, such that driving of the drive belt 116 rotates the wheels 112, 114 and drives the bot in the x- or y-direction. The slave wheel 120 is mounted on the bot skeleton 100 and guides the drive belt 116 along a drive belt route. In this embodiment, the slave wheel 120 is mounted to the upper portion 145 of the bot 100 to guide the drive belt 116 along the upper portion 145 of the bot skeleton 100. The drive belt 116 extends around the wheels 112 mounted on the wheel chassis 126 or the lower portion of the bot skeleton 100. As illustrated, the tensioning wheels 122 are mounted on the wheel chassis 126 and guide the drive belt 116 across the lower portion of the bot skeleton 100. The tensioning wheels 122 are movably mounted to chassis 126 with springs (not shown) and are intended to keep the drive belt 116 taut and maintain engagement of the drive belt 116 with the wheels 112.

To enable the bot 100 to move on the different wheels in the x- and y-directions, the bot 100 includes a direction-change assembly 128 for selectively engaging either the first set of wheels 112 with the first set of tracks 22a or the second set of wheels 114 with the second set of tracks 22b. The direction-change assembly 128 comprises a direction-change mechanism 130 on each face or side of the bot or bot skeleton 100 for each set of wheels, each direction-change mechanism 130 being configured to raise and lower the first set of wheels 112 and/or the second set of wheels 114 relative to the drive wheel 118 and relative to the body or skeleton 100, thereby enabling the bot 100 to selectively move in either the x-direction or the y-direction across the tracks 22a, 22b of the storage structure 1. In some instances, both sets of wheels 112, 114 may be in contact with the respective set of tracks 22a, 22b at the same time (e.g. when the bot is in the parked configuration, described further below). Thus, the direction-change assembly 128 can selectively position the first 112 and second 114 sets of wheels for x-direction movement, y-direction movement or parked configuration of the bot 100.

The direction-change mechanism 130 may include one or more linear actuators, rotary components or other means for raising and lowering at least one set of wheels relative to the body of the bot 100 to bring the at least one set of wheels out of and into contact with the tracks 22a, 22b. In some examples, only one set of wheels is configured to be raised and lowered, and the act of lowering the one set of wheels may effectively lift the other set of wheels clear of the corresponding tracks 22a, 22b while the act of raising the one set of wheels may effectively lower the other set of wheels into contact with the corresponding tracks 22a, 22b. In other examples, both sets of wheels may be raised and lowered, advantageously resulting in the body of the bot staying substantially at the same height. This advantageously results in the weight of the body and the components mounted thereon not needing to be lifted and lowered by the direction-change mechanism 130.

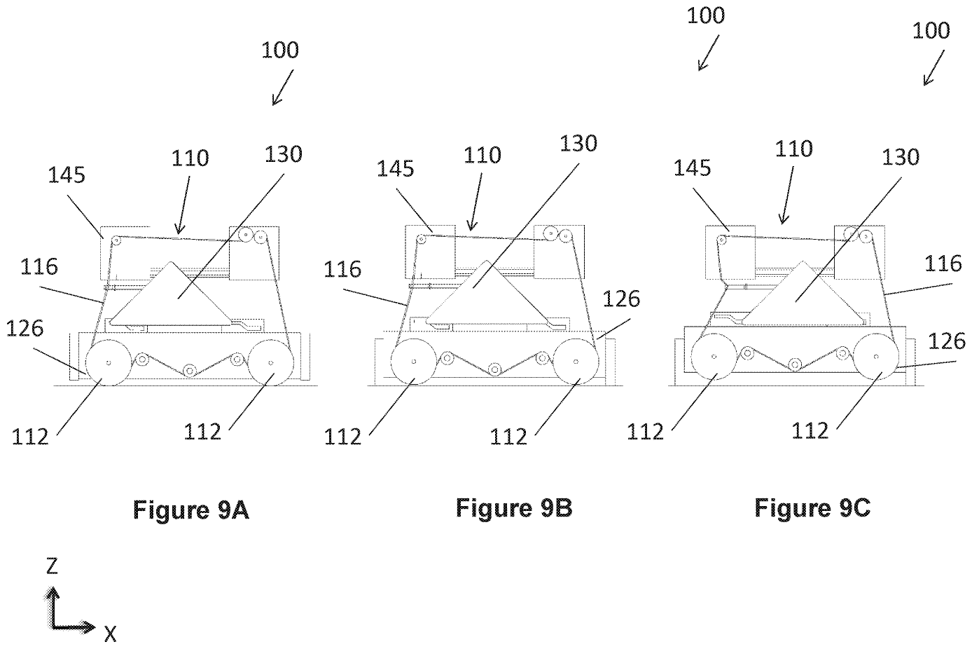

As shown in FIGS. 9A, 9B, and 9C, the first 112 and second 114 set of wheels can be moved vertically to lift/raise the wheels clear of the tracks 22a, 22b or lowered onto the tracks 22a, 22b by means of the direction-change mechanism 130. FIGS. 9A, 9B, and 9C show front views of the bot with the direction-change mechanism 130 on the front face of the bot and the bot in three configurations: x-direction movement (FIG. 9A), parked (FIG. 9B) and y-direction movement (FIG. 9C).

FIG. 9A shows the bot 100 in the x-direction movement configuration, where the x-direction wheel chassis 126 is lowered (i.e. down in the z-direction) such that the first set of wheels is lowered for engagement with the x-direction tracks, whereas the y-direction chassis is raised (i.e. lifted in the z-direction) such that the second set of wheels is raised for disengagement with the y-direction tracks (not shown). This results in movement of the bot 100 in the x-direction. FIG. 9B shows the bot 100 in the parked configuration, where both the x-direction wheel chassis 126 and the y-direction wheel chassis 126 are lowered (i.e. down in the z-direction) such that both the first 112 and second 114 sets of wheels are lowered for engagement with their respective tracks 22a, 22b. In this arrangement, the wheel chassis 126 are at the same vertical or z-direction level and the bot 100 is unable to move in either the x- or y-directions. FIG. 9C shows the bot 100 in the y-direction movement configuration, where the y-direction wheel chassis 126 is lowered (i.e. down in the z-direction) such that the second set of wheels is lowered for engagement with the y-direction tracks (not shown), whereas the x-direction chassis is raised (i.e. lifted in the z-direction) for disengagement with the x-direction tracks. This results in movement of the bot 100 in the y-direction. Each of the wheel chassis 126 are moved vertically (i.e. . in the z-direction) by connection to their respective direction-change mechanism 130. Thus, each set of wheels has two positions: wheels raised position, relative to the drive wheel 118, for disengagement with the tracks and wheels lowered position, relative to the drive wheel 118, for engagement with the tracks.

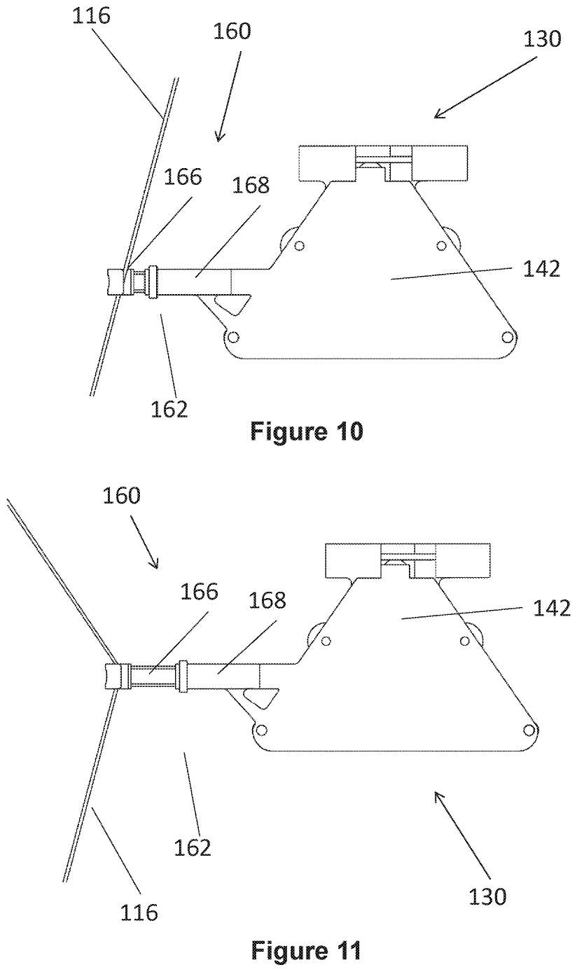

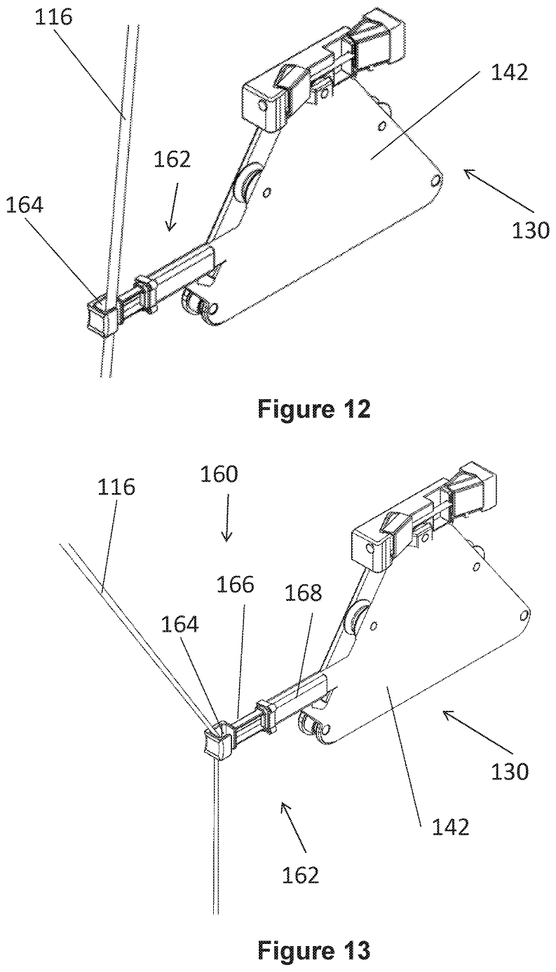

Turning now to FIGS. 10 to 13, these show detailed views of the take-up arm 160. FIGS. 10 and 11 show the take-up arm 160 in front view and FIGS. 12 and 13 show the take-up arm 160 in front perspective view. As shown by FIGS. 10 to 13, the take-up arm 160 comprises a limb 162 comprising a first portion 166 and a second portion 168, where the first portion 166 is horizontally displaceable relative to the second portion 168 such that horizontal movement of the first portion 166 in the first direction extends the first portion 166 away (FIGS. 11 and 13) from the second portion 168 and moves the limb 162 from a retracted configuration (FIGS. 10 and 12) to an extended configuration (FIGS. 11 and 13). In the extended configuration, the second portion 168 extends and telescopes out from the first portion 166, whereas in the retracted configuration, the second portion 168 is telescoped back into and retracted into the first portion 166. When the take-up arm 160 is in the retracted configuration, it does not pull to tension the drive belt 116. When the take-up arm 160 is in the extended configuration, the limb 162 pulls the drive belt 116 in the first direction thereby extending the route of the drive belt 116 and tensioning the drive belt 116 to reduce any slack in the drive belt.

The drive belt 116 is routed through a slot 164 in the second portion 168 of the limb. In this way, movement of the second portion 168 results in the limb pulling the drive belt 116.

The limb 162 is attached to one side of the direction-change mechanism 130 such that movement between the limb 162 and the wheel positions is mechanically coordinated and linked. In this embodiment, the direction-change mechanism 130 is in the form of a cam mechanism comprising a traveller 142, a pair of brace elements 144 and a cam profile 146 arranged as two slots, one in each face of the brace elements 144. The first portion 168 of the limb is attached to the traveller 142 such that horizontal movement of the traveller 142 results in horizontal movement of the first potion of the limb 162 thereby moving the limb between the retracted and extended configurations.

Turning back to FIG. 7, this shown the direction-change mechanism 130 and the various components of the cam mechanism. The brace elements 144 are attached to, joined to or uniform with the wheels chassis 126, such that vertical movement of the brace elements 144 results in vertical movement of the wheels chassis 126, and therefore the wheels supported on the respective wheel chassis 126. The brace elements 144 are arranged at opposed ends of the wheel chassis 126 and each slot 146 is of substantially identical profile. The traveller 142 comprises a cam follower for each cam slot, each cam follower engages with its respective cam slot and travels the length of the cam slot. The traveller 142 also comprises a guide follower which engages with a traveller guide 148 in the upper portion 145 of the bot skeleton, which enables horizontal movement of the traveller 142 and prevents vertical movement of the traveller 142 (i.e. the traveller is fixed in the vertical or z-direction).

In this embodiment, the traveller 142 is substantially triangular with the guide follower towards the top corner of the triangular traveller and a cam follower towards each lower corner of the triangular traveller for engagement with the cam slots 146.

As shown in FIG. 8, each cam slot extends between a first limit 152 and second limit 154. The slot extends from the first limit 152 substantially horizontally, before sloping downwards (in the z-direction) and then continuing substantially horizontally to the second limit 154. As the traveller 142 moves horizontally (as guided by the traveller guide 148), the cam followers move within the cam slots 146 from the first limit 152 to the second limit 154 and raise the brace elements144 and thus the wheel chassis 126, by an amount equal to the vertical change in the cam slots 146. The pair of wheels are fixedly attached to the wheel chassis 126, such that as the brace elements 144 are moved vertically, the pair of wheels are moved vertically by an equal amount. Thus, as the traveller 142 moves horizontally in the first direction, the cam followers move within the cam slots 146 from the first limit 152 to the second limit 154 and raise the brace elements 144, thereby raising the pair of wheels for disengagement with their respective tracks 22a, 22b. As the traveller 142 moves horizontally in the second direction (opposite to the first direction), the cam followers move within the cam slots 146 from the second limit 154 to the first limit 152 and lower the brace elements 144, thereby lowering the pair of wheels for engagement with their respective tracks 22a, 22b.

The traveller 142 is able to move horizontally and is fixed in a vertical direction, while the brace elements 144 and the wheels chassis are fixed horizontally and are able to move vertically. The pair of wheels are fixedly attached to the wheel chassis 126, such that as the brace or brace elements 144 are moved vertically, the pair of wheels are moved vertically by an equal amount, thereby raising or lowering the wheels, i.e. moving the wheels between their lowered position and their raised position (see FIGS. 9A, 9B, ad 9C).

As illustrated in FIGS. 7, 8, 9A, 9B, and 9C, the brace comprises two brace elements 144 and the cam profile comprises two slots, one in each brace element. In other embodiments, the cam mechanism may comprise a single brace element, e.g. extending substantially the length of the wheel chassis, with a slot at each opposed end of the brace element.

The skilled person will appreciate that the motion described above of the traveller can be achieved with a cam profile 146 arranged as a single cam slot in the brace 144 and where the traveller includes a single follower which engages with the cam slot. In other embodiments, the cam mechanism may comprise more than two cam slots 146. It will also be appreciated that the cam profile may be designed to provide any desired horizontal and/or vertical movement profile.

The direction-change mechanism in FIG. 9A is in the x-direction position with the first set of wheels lowered for engagement with the x-direction tracks and the second set of wheels raised for disengagement with the y-direction tracks for movement of the bot 100 in the x-direction. The direction-change mechanism in FIG. 9B is in the park position with the first and second sets of wheels lowered for engagement with their respective tracks 22a, 22b. The direction-change mechanism in FIG. 9C is in the y-direction position with the first set of wheels raised for disengagement with the x-direction tracks and the second set of wheels lowered for engagement with the y-direction tracks (not shown) for movement of the bot 100 in the y-direction. It will be appreciated that while the cam mechanism of this embodiment comprises a triangular traveller 142, the traveller may be designed to any shape to provide the desired movement of the sets of wheels.

As each set of wheels is moved between the wheels raised position and the wheels lowered position, the distance between the upper portion 145 of the drive belt assembly 110 and the wheels changes. In particular, as a set of wheels is moved from the wheels lowered to the wheels raised position, the distance between the upper portion 145 of the drive belt assembly 110 (i.e. the upper portion 145 of the skeleton 100) and the wheels is reduced (compared to when the set of wheels is lowered for engagement with the track). This can cause the drive belt 116 to become slack and lose engagement with the first or second set of wheels.

Referring first to FIG. 9a, the traveller 142 is in a first position with the take-up arm 160 in the retracted configuration and the wheels in the lowered position. When the wheels are in the lowered position, the drive belt 116 is routed along the top of the bot skeleton 100 and around the wheels with the drive belt 116 at the required tension to stay in contact with the drive wheel 118 and the wheels as required to drive the bot 100. As such, the limb 162 is retracted and not tensioning the drive belt 116.

Referring now to FIG. 9c, the wheels are moved from their lowered position to their raised position and the take-up arm 160 is moved to the extended configuration. The traveller 142 is moved horizontally in the first direction relative to the drive wheel 118 from the first position to a second position such that the first portion of the limb is moved in the first direction and the second portion of the limb telescopes out from the first portion (thereby moving the limb to the extended configuration). The limb 162 pulls the drive belt 116 to tension the drive belt 116 and extend the drive belt route, thereby eliminating any slack in the drive belt 116. The take-up arm 160 compensates for any potential slackening of the drive belt when the wheels are in the raised position and ensures the belt is tensioned as needed to maintain contact with the drive wheel 118 and the wheels as required to drive the bot.

Referring to FIG. 9b, both the first and second set of wheels are in their lowered position and the bot is in the parked configuration. The traveller142 of the direction-change mechanism is moved horizontally in the first direction to an intermediate position (between the first position and the second position). Horizontal movement of the traveller 142 in the first direction pulls the first portion of the limb away from the second portion, such that the second portion telescope out from the first portion and the limb is moved into the extended configuration. However, as the traveller is moved to the intermediate position, the limb does not pull the drive belt and does not apply any tension to the drive belt 116.

The skilled person will know of a number of ways for extending the second portion 168 without applying tension on the drive belt 116. For example, friction between the first and second portion of the limb may be so minor or negligible that the second portion 168 can easily extend from the first portion 166 without applying tension on the drive belt 116. Alternatively or in addition to this, the tension on the drive belt 116 (with the wheels in the lowered position) may be such that any pull caused by the limb 162 on the drive belt 116 as the traveller 142 moves from the first position to the intermediate position is negligible or minimal compared to the tension already in the drive belt 116 when the wheels are in the lowered position. As such, when the bot 100 is in the parked configuration, the take-up arm 160 does not apply any pre-tension to the drive belt 116. Tension on the drive belt 116 is only applied when the direction-change mechanism moves the wheels into the wheels raised position and the limb 162 is moved further in the first direction and pulls the drive belt 116 in the first direction to tension the drive belt 116.

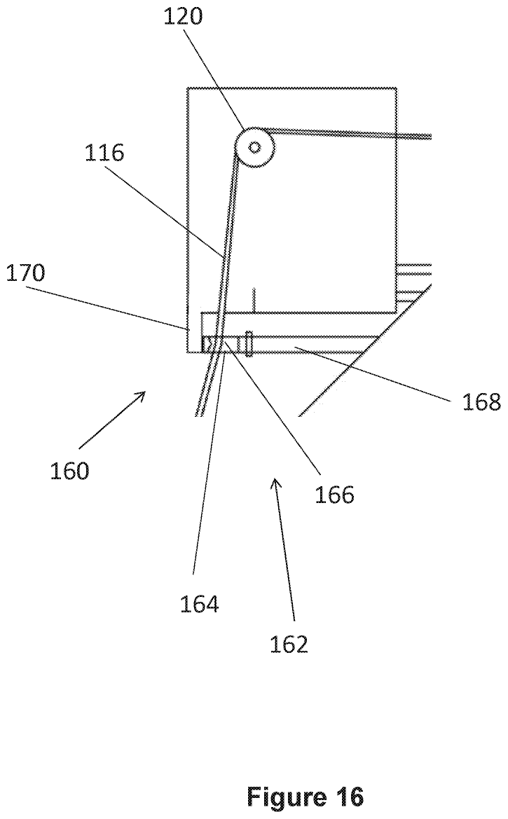

Referring to FIGS. 7 and 16, the drive belt assembly 110 comprises a stop tab 170. As the traveller 142 of the direction-change mechanism 130 moves in the second direction, the limb is moved horizontally in the second direction until the second portion is positioned to abut against the stop tab 170. Continued movement of the traveller 142 in the second direction pushes and retracts the second portion into the first portion thereby moving the limb into the retracted configuration. In this embodiment, the stop tab 170 extends downwards from the upper portion 145 of the bot skeleton and is uniform with the upper portion of the bot skeleton. However, the skilled person will appreciate that the stop tab 170 may be attached to the bot skeleton and may be anywhere on the bot skeleton provided movement of the limb 162 in the second direction positions the second portion 168 against the stop tab 170 and continued movement of the limb in the second direction retracts the second portion 168 into the first portion 166.

Thus, the limb 162 is configured to move from the extended configuration to the retracted configuration by movement of the traveller 142 in the horizontal direction. The take-up arm 160 advantageously does

not require any spring to return the limb 162 from the extended configuration to the retracted configuration. As the traveller 142 moves horizontally, as described above, to raise or lower the wheels for disengagement or engagement of the wheels with the tracks 22a, 22b, the limb 162 is moved horizontally between the retracted and extended configurations ensuring it is in the required configuration when the direction-change mechanism 130 positions the wheels in the raised or lowered positions.

The take-up arm 160 and the direction-change mechanism 130 being mechanically linked in this way allows movement of the wheels in the vertical direction and movement of the take-up arm 160 between the configurations to be actuated by the same actuator. This ensures that the take-up arm 160 (and thus the limb 162) is in the required configuration depending on the position of the wheels.

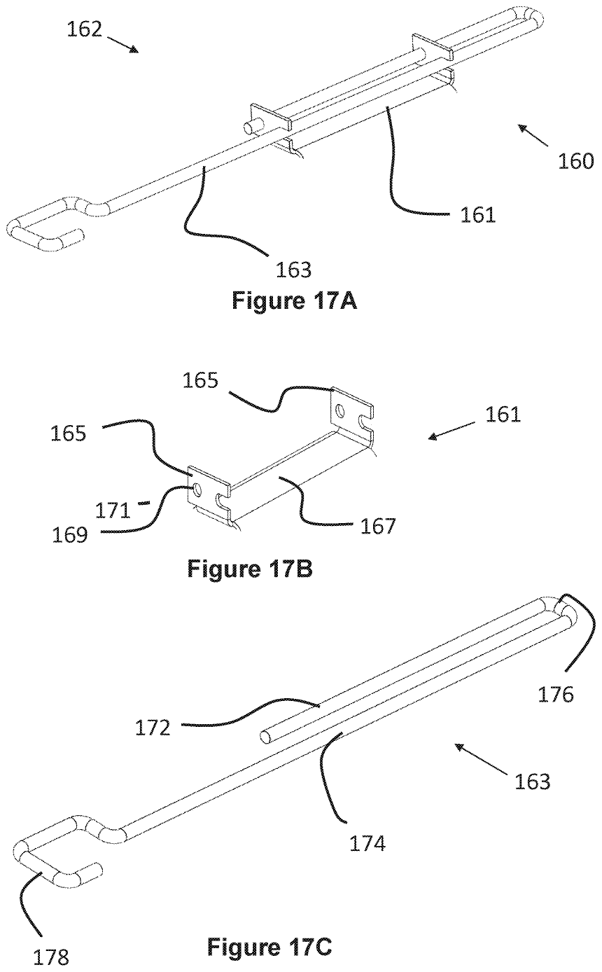

FIGS. 17A and 17B illustrate another embodiment of a take-up arm 160. The limb 162 of the take-up arm 160 comprises a fixed portion 161 and a sliding portion 163. FIG. 17A illustrates the take-up arm 160, showing the sliding portion 163 supported and constrained by the fixed portion 161. The sliding portion 163 is able to move horizontally relative to the fixed portion 161.

The fixed portion 161, illustrated in FIG. 17B, comprises two parallel end plates 165 spaced apart by a longitudinal plate 167. The end plates 165 are substantially perpendicular to the longitudinal plate 167. Each of the two end plates 165 comprises a hole 169 and a notch 171. The holes 169 and notches 171 are sized to receive the sliding portion 163.

The sliding portion 163 is illustrated in FIG. 17C. The sliding portion in the illustrated example is formed from a single rod bent into a particular shape. The sliding portion 163 has a first straight portion 172, connected by an elbow 176 turning through an angle of 180° to a second straight portion 174, parallel to the first straight portion 172. At the opposite end to the elbow 176, the second straight portion 174 ends in a hook 178.

The fixed portion 161 and sliding portion 163 are assembled together as illustrated in FIG. 17A. The first straight portion 172 passes through the holes 169 in the two end plates 165 of the fixed portion 161. The second straight portion 174 is held within the notches 171 of the two end plates 165.

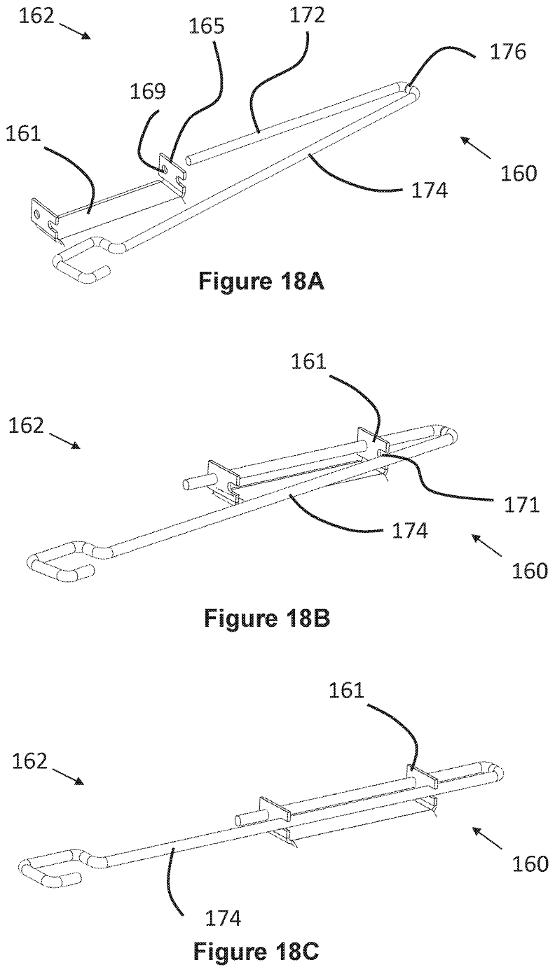

FIGS. 18A, 18B, and 18C illustrate how the sliding portion 163 and the fixed portion 161 are assembled together. Firstly, the first straight portion 172 is inserted into the holes 169 in the two end plates 165 of the fixed portion 161, as shown in FIG. 18A. The elbow 176 is flexible enough to allow the second straight portion 174 to be moved out of the way while the first straight portion 172 is inserted into the fixed portion 161. The second straight portion 174 can then be inserted into the notches 171 in the end plates 165 of the fixed portion 161, as shown in FIG. 18B. When assembled as in FIG. 18C, the first straight portion 172 and the second straight portion 174 are constrained by the holes 169 and notches 171 respectively in the end plates 165. The sliding portion 163 is therefore able to slide freely in the direction parallel to the straight portions, but constrained to move in this direction only.

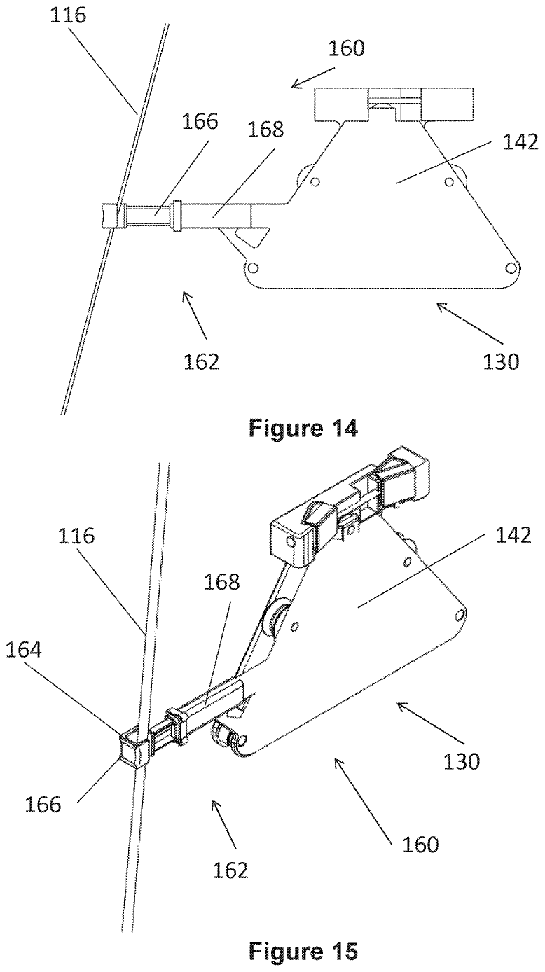

In use, the take-up arm as illustrated in FIGS. 17A, 17B, and 17C functions in the same way as the take-up arm described above with reference to FIGS. 7-16. The fixed portion 161 is mounted to the traveller 142 of the cam mechanism, and the sliding portion 163 is able to slide horizontally within the fixed portion 161 in order to move the take-up arm between the extended position and the retracted position. The hook 178 of the sliding portion 163 engages with the drive belt 116.

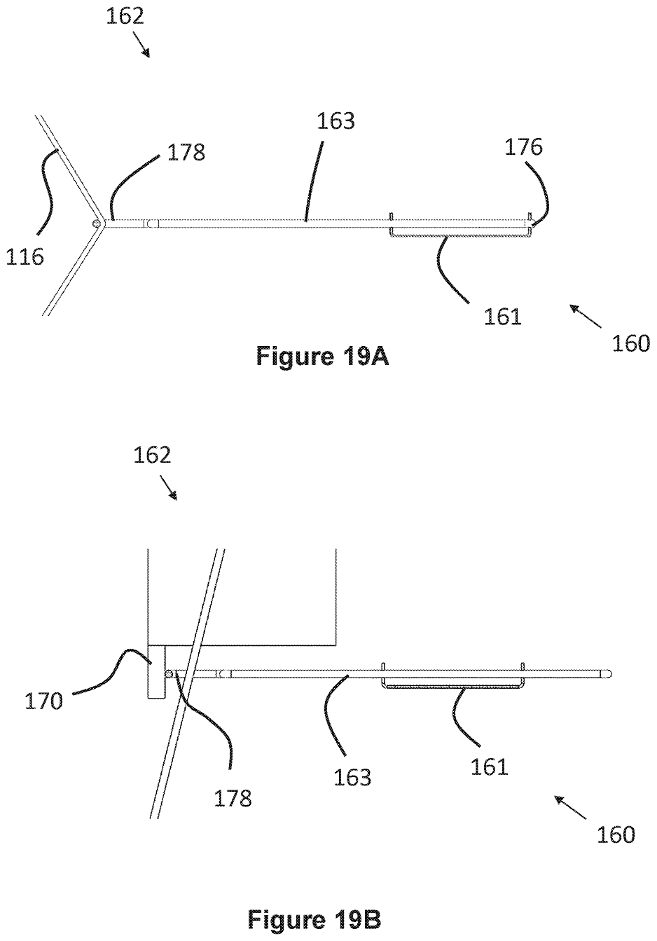

As the traveller 142 of the direction-change mechanism 130 moves horizontally in one direction, the wheels 112 are lifted up and disengage from the tracks. The fixed portion 161 is mounted on the traveller 142, so also moves horizontally. The hook 178 of the sliding portion 163 engages with the drive belt 116. When the traveller 142 reaches the end of its travel, the fixed portion 161 reaches the end of the sliding portion 163 so that the elbow 176 of the sliding portion abuts the end plate 165 of the fixed portion. The elbow 176 effectively acts as a stop, and prevents the sliding portion from sliding all the way out of the fixed portion 161. The hook 178 of the sliding portion 163 pulls the drive belt 116 to tension the drive belt 116 and extend the drive belt route, thereby eliminating any slack in the drive belt 116. This is the extended position, as illustrated in FIG. 19A.

As the traveller 142 of the direction-change mechanism 130 moves horizontally in the opposite direction, the wheels 112 are lowered in order to engage with the tracks. The take-up arm 160 moves horizontally with the traveller 142 until the hook 178 of the sliding portion 163 abuts the stop 170. As the traveller continues to move horizontally, the sliding portion 163 moves relative to the fixed portion 161 as the fixed portion 161 is pushed towards the stop 170 by the motion of the traveller 142. When the traveller 142 reaches the end of its travel, the wheels 112 are fully lowered and engaged with the tracks. This is the retracted position, as illustrated in FIG. 19B.

In this document, the word “comprise” and its derivatives are intended to have an inclusive rather than an exclusive meaning. For example, “x comprises y” is intended to include the possibilities that x includes one and only one y, multiple y's, or one or more y's and one or more other elements. Where an exclusive meaning is intended, the language “x is composed of y” will be used, meaning that x includes only y and nothing else.

In this document, the language “movement in the n-direction” (and related wording), where n is one of x, y and z, is intended to mean movement substantially along or parallel to the n-axis, in either direction (i.e. towards the positive end of the n-axis or towards the negative end of the n-axis).

In this document, the word “connect” and its derivatives are intended to include the possibilities of direct and indirection connection. For example, “x is connected to y” is intended to include the possibility that x is directly connected to y, with no intervening components, and the possibility that x is indirectly connected to y, with one or more intervening components. Where a direct connection is intended, the words “directly connected”, “direct connection” or similar will be used. Similarly, words such as “support”, “mount” and their derivatives are intended to include the possibilities of direct and indirect contact.

In this document, some words such as “load handling device”, “vehicle” and “bot” are used interchangeably. Similarly, words “body”, “frame” and “skeleton” of the load handling device; “rails” and “tracks” of the storage frame; “bin”, “container”, or “tote” of the storage system may be used interchangeably.

All optional and preferred features and modifications of the described embodiments and dependent claims are usable in all aspects taught herein. Furthermore, the individual features of the dependent claims, as well as all optional and preferred features and modifications of the described embodiments are combinable and interchangeable with one another.

It will be appreciated that a take-up arm can be designed for a particular application using various combinations of the arrangements described above. It will be appreciated that the features described herein may all be used together in a single system. In other embodiments, some of the features may be omitted. The features may be used in any compatible arrangement. Many variations and modifications not explicitly described above are possible without departing from the scope as defined in the appended claims.

What is claimed is:

1. A take-up arm for a load handling device, the load handling device comprising:
a body mounted on a first set of wheels being arranged to engage with a first set of parallel tracks and a second set of wheels being arranged to engage with a second set of parallel tracks;
a direction-change assembly arranged to raise or lower the first set of wheels and or lower or raise the second set of wheels for engaging and disengaging the wheels with the parallel tracks; and
a plurality of drive belt assemblies each comprising a drive belt, a drive wheel, and a take-up arm, wherein the drive belt is routed around a respective set of wheels, and the first set of wheels and the second set of wheels are driven by respective drive belt assemblies, the first set of wheels and the second set of wheels being driven wheels;
the take-up arm comprising:
a limb extending from one side of the direction-change assembly, the limb being horizontally displaceable relative to the drive wheel and the driven wheels when the direction-change assembly moves to raise or lower the set of wheels, and the drive belt is further routed around the limb, the drive belt having a drive belt route, wherein
the limb is extendable, movable between a retracted position and an extended position, and wherein
the limb is arranged to be in the retracted position when the wheels are lowered, and the limb is arranged to be in the extended position when the wheels are raised thereby extending the route of the drive belt and take-up slack in the drive belt when the wheels are in the raised position.

2. A take-up arm according to claim 1, wherein the limb comprises a first portion and a second portion, and the second portion is arranged to telescope out from the first portion.

3. A take-up arm according to claim 1, further comprising a stop tab located on the body of the load handling device and arranged to engage with the limb to push the limb from the extended position to the retracted position with movement of the direction-change mechanism from a wheels raised position to a wheels lowered position.

4. A take-up arm according to claim 1, wherein the limb comprises a slot for routing the drive belt through.

5. A take-up arm according to claim 1, wherein the limb comprises a hook for routing the drive belt through.

6. A load handling device for operating on a grid framework storage structure comprising:
a first set of parallel rails or tracks and a second set of parallel rails or tracks extending substantially perpendicularly to the first set of rails or tracks in a substantially horizontal plane to form a grid pattern comprising a plurality of grid spaces, wherein the grid is supported by a set of uprights to form a plurality of vertical storage locations beneath the grid for containers to be stacked between and be guided by the uprights in a vertical direction through the plurality of grid spaces,
the load handling device comprising:
a body mounted on a first set of wheels being arranged to engage with the first set of parallel tracks and a second set of wheels being arranged to engage with the second set of parallel tracks, a direction-change assembly arranged to raise or lower the first set of wheels and or lower or raise the second set of wheels for engaging and disengaging the wheels with the parallel tracks; and
a plurality of drive belt assemblies each comprising a drive belt, a drive wheel, and a take-up arm, wherein the first set of wheels and the second set of wheels are driven wheels driven by respective drive belt assemblies, and raised or lowered by the direction-change assembly, and wherein
the take-up arm comprises a take-up arm according to claim 1.

7. A load handling device according to claim 6, comprising four drive belt assemblies, one arranged on each side of the load handling device.

8. A load handling device according to claim 6, wherein the take-up arm is attached to the direction-change assembly and movement of the limb is coordinated with raising or lowing movement of the wheels.

9. A load handling device according to claim 6, wherein the direction-change mechanism can be arranged in an intermediate position where when the first set of wheels and the second set of wheels are lowered, each of the respective limbs are arranged in an intermediate position where the limb is extended.

10. A grid-based automated storage and retrieval system comprising:
a grid framework structure comprising:
a first set of parallel rails or tracks and a second set of parallel rails or tracks extending substantially perpendicularly to the first set of rails or tracks in a substantially horizontal plane to form a grid pattern comprising a plurality of grid spaces, wherein the grid is supported by a set of uprights to form a plurality of vertical storage locations beneath the grid for containers to be stacked between and be guided by the uprights in a vertical direction through the plurality of grid spaces,
at least one load handling device according to claim 6 operating on the grid framework structure; and
a centralised control utility for controlling the at least one load handling device.
